(19) United States
(12) Patent Application Publication
(10) Pub. No.: US 2025/0303323 A1
(43) Pub. Date: Oct. 2, 2025

(54) MULTI-MODE ANTI-MATRIX EXTRACTION COLUMN

(71) Applicant: HUNAN DEMETER INSTRUMENTS CO., LTD., Changsha, Hunan (CN)

(72) Inventors: Feng WANG, Changsha, Hunan (CN); Kai YU, Changsha, Hunan (CN); Kaidian WU, Changsha, Hunan (CN)

(21) Appl. No.: 18/862,978

(22) PCT Filed: Jan. 4, 2023
(86) PCT No.: PCT/CN2023/070265

§ 371 Date: Nov. 5, 2024

(30) Foreign Application Priority Data
Aug. 22, 2022 (CN) 202211002337.7

(51) Int. Cl. B01D 15/38; B01D 15/22; G01N 1/34

(52) U.S. Cl. CPC B01D 15/3847; B01D 15/22; G01N 1/34

(57) ABSTRACT

Provided is a multi-mode anti-matrix extraction column. With the inflow end of a mobile phase serving as an upper end, the extraction column includes a column head, a front end column cap, a column tube, a tail end column cap and a column head which are sequentially connected from top to bottom, wherein the column tube is internally filled with a stationary phase, an inner cavity of the column tube is cylindrical, the column tube is divided into an upper section and a lower section, and the inner diameter of the upper section is larger than that of the lower section; and a pressure-variable pore structure is provided on an upper end of the front end column cap, and includes upper, middle and lower layers, i.e., an elastic soft board, a polymer filter membrane and a supporting pore plate in sequence from top to bottom.

### TECHNICAL FIELD

The present disclosure relates to the field of liquid chromatography columns, in particular to a multi-mode anti-matrix extraction column.

### BACKGROUND

In pure extraction systems, chromatographic columns are often used for sample pretreatment, and the chromatographic columns used for sample treatment are called extraction columns. In two-dimensional liquid chromatography analysis and detection, the extraction column is mainly used for the primary separation, purification and concentration of a sample. In this process, the extraction column is subjected to contamination from various impurities in the sample, and the various impurities in the sample are easily accumulated at an inlet end, resulting in high pressure at the inlet end, so that the service life of the extraction column is seriously affected.

The structure of an extraction column usually includes a column tube, a sieve plate, and a column cap. The sieve plate in the column cap is generally a stainless steel sintered mesh plate with a pore size of 0.1 μm-3 μm. When a mobile phase flows through a chromatographic column, it is usually intercepted by the sieve plate first. However, due to a large number of impurities in a sample, especially the proteins in a biological sample, a mass aggregation phenomenon will occur after the proteins are intercepted by the sieve plate. Therefore, with the more times the sample injection to the chromatographic column, the longer the time, the more severe the degree of sieve plate blockage, which is also the most common problem in modern liquid chromatography columns. The extraction column usually has to withstand a larger injection volume than the ordinary chromatographic column, and the extraction column often has to withstand an injection volume of 100 microliters or even larger, so the extraction column is more prone to blockage. The service life of the extraction column for general sewage treatment or biomass samples is difficult to exceed 200 needles.

The existing solution is generally to perform ultrasonic cleaning on the extraction column or replace a filler of a column head to repair the column head, which requires a high degree of specialization and is limited in the ability to solve the problem.

The applicant has obtained a patent (with application No. 201410705067.5), entitled Liquid Chromatograph with Online Cleaning Function, which is mainly aimed at the online cleaning of a first chromatographic column and an intermediate chromatographic column of a two-dimensional liquid chromatography, and has a reverse cleaning function. Of course, this is just one of specific chromatographic systems. Cleaning chromatographic columns are capable of implementing online cleaning or offline reverse cleaning.

During liquid chromatography analysis, some samples are relatively complex in components and low in target content, requiring large volume injection during online extraction, so as to achieve the function of enriching and purifying target substances. However, it is difficult for the conventional extraction column to withdraw large volume injection (generally, the regular injection volume is about 20-50 microliters). Furthermore, the peak area of the conventional extraction column increases non-linearly with the increase of the injection volume. Most of the conventional extraction columns are mostly of equal diameters, and the linear velocities of mobile phases in the columns remain the same. For some drugs that are not easy to focus, problems such as poor focusing ability will occur. Moreover, impurities such as particles are generated in the mobile phases. The smaller the radius of a column head, the easier it is for the column pressure to rise, which affects the service life of the extraction column.

After searching, it is found that there are also non-equal diameter chromatographic columns in the prior art. For example, CN02106928.X discloses a conical high performance liquid chromatography preparative column. It is mainly composed of a column head, a column body and a column tail. It is a tapered column with a column head inlet inner diameter (2R) greater than a column tail outlet inner diameter (2r). The column head consists of a conical liquid flow guide groove, a distribution plate and a sieve plate to form a liquid flow distribution system. The distribution plate is composed of a plurality of radial liquid flow channels, concentric circular liquid flow collection channels and seepage holes. A uniform transition cone has a column inlet inner diameter of 2R ranging from 10 mm to 2000 mm, a column outlet inner diameter of 2r ranging from 3 mm to 1800 mm, and a column length of L ranging from 5 cm to 100 cm. The cone angle is within a range of 1°-20°, and the cone can be filled with various types of chromatographic separation media. This conical preparative column can significantly improve the column efficiency and sample loading, with a lower dilution effect on separated components compared to cylindrical chromatography columns. However, this chromatographic column is complex to process and is not a regular cylindrical chromatographic column.

CN 201110071563.6 discloses a parabolic high performance liquid chromatography preparative column. The capillary liquid chromatography preparative column includes: a column head located at an upper part of a column body, the parabolic tubular column body, and a column tail located at a lower part of the column body, where two special seal inserts are respectively disposed at an inlet end and an outlet end of the parabolic tubular column body, and the column body is designed in a parabolic shape, with a parabolic equation corresponding to the flow rate, so that a perfect plug-shaped chromatographic band can be obtained, and the column efficiency of the chromatographic column is greatly improved; and the inner diameter of the column body gradually decreases, which increases the sample loading of the chromatographic column, and has a certain enrichment effect on the sample. This type of chromatographic column should still be in the theoretical stage, with high processing costs.

In addition, in the conventional online extraction column, a sample undergoes various irregular movements with a mobile phase after passing through a stationary phase due to mass transfer resistance, resulting in an increase in the height equivalent to a theoretical plate of the chromatographic column and a decrease in the column efficiency of the extraction column.

Furthermore, the conventional extraction column typically uses C18 as a stationary phase, which is not ideal for extracting and separating complex samples. Even after solid-phase extraction with a filler, there are still many impurities that interfere with the analysis of a target compound.

Therefore, it is of great significance to study a multi-mode anti-matrix extraction column to solve the technical problems existing in the prior art.

### SUMMARY

### (I) in View of the Shortcomings of the Prior Art, the Objects of the Present Disclosure are:

The first object of the present disclosure is to provide an extraction column, which can solve the problem of the extraction column being easily blocked, is easy to clean, and prolongs the service life of a chromatographic column.

The second object of the present disclosure is to provide an extraction column, which can be adapted to large volume injection and still has good column efficiency in large volume injection. Furthermore, as the injection volume increases, the peak area shows a linear increase. The large volume injection refers to an injection volume of 200 μL and above.

The third object of the present disclosure is to provide an extraction column that rectifies the fluid morphology and flow rate of a fluid entering the extraction column, so as to enable target substances in a sample to be rearranged after rectification, and move forward in unison; and after entering a detector, a relatively normal peak type is obtained, thus maintaining high column efficiency.

The fourth object of the present disclosure is to provide an extraction column, which can adapt to the extraction and separation of complex samples. When being used for separating the complex sample, the extraction column is good in separation effect, and still has good column efficiency.

### (II) in Order to Achieve the Objects of the Present Disclosure, the Technical Solutions of the Present Disclosure are:

Regarding the first and second objects of the present disclosure, the technical solution I of the present disclosure is:

Provided is a multi-mode anti-matrix extraction column. With the inflow end of a mobile phase serving as an upper end, the extraction column includes a column head, a front end column cap, a column tube, a tail end column cap and a column head which are sequentially connected from top to bottom, where an inner cavity of the column tube is cylindrical, the column tube is divided into an upper section and a lower section, and the inner diameter of the upper section is larger than that of the lower section; and a pressure-variable pore structure is provided on an upper end of the front end column cap, and includes an elastic soft board, a polymer filter membrane and a supporting pore plate in sequence from top to bottom.

Preferably, the elastic soft board includes a fixed ring and an elastic sieve plate, and the elastic sieve plate is located inside the fixed ring.

Preferably, the preferred material for the fixed ring is a PEEK ring, made of PEEK. The preferred material for the PE sieve plate is polyethylene, which has the characteristics such as high strength and low dissolution. The thickness of the PE sieve plate is within a range of 0.5 mm-8 mm.

Preferably, the thickness of the elastic soft board is 0.1 mm-10 mm, preferably 0.5 mm-8 mm; and the pore size of the elastic soft board is 5 microns to 10 microns.

Preferably, the thickness of the polymer filter membrane is 0.05 mm to 3 mm, preferably 0.1 mm to 2 mm, and further preferably 0.1 mm to 0.5 mm; and the polymer filter membrane can intercept substances with molecular weights greater than 3000 Da.

Preferably, the polymer filter membrane is made of a material capable of withstanding organic, acid and alkali reagents, and the polymer filter membrane may be made of polyether sulfone resin or polypropylene.

Preferably, the front end column cap is disposed at an inlet end of the column tube, and the tail end column cap is disposed at an outlet end of the column tube. The inlet end and outlet end of the column tube are accommodated inside the column head. Internal threads are provided in the column head, and the column tube and the column head are connected by the threads.

Preferably, the structure of the supporting pore plate may be exactly the same as that of the clastic soft board.

Preferably, the length of the upper section accounts for ⅕ to 3/10 of the length of the column tube. After extensive research by the inventor, it is found to be suitable within this range and can be adapted to large volume injection while maintaining overall good column efficiency without significantly increasing costs and analysis time.

Preferably, the ratio of the inner diameter of the upper section to the inner diameter of the lower section is 1.2 to 1.5. After extensive research by the inventor, it is found to be suitable within this range and can be adapted to large volume injection while maintaining overall good column efficiency without significantly increasing costs and analysis time.

Preferably, the outer circumference of the column tube is provided with a first connecting section and a first connecting section for connection with the column head, and the outer diameters of the first connecting section and the second connecting section are greater than the outer diameter of the column tube.

Preferably, the column head is internally provided with an inflow hole for inflow of the mobile phase or an outflow hole for outflow of the mobile phase.

Preferably, as a non-equal-diameter extraction column, the column tube and the column head are both made of stainless steel.

Preferably, the upper section and the lower section are respectively filled with different fillers.

Preferably, the upper section may be filled with reverse and ionic fillers, and the lower section may also be filled with reverse and ionic fillers. The particle size of the filler filled into the upper section is larger than that of the filler filled into the lower section. The target substance adsorption effect of the filler filled into the upper section is better than that of the filler filled into the lower section. The two types of fillers are separated from each other by a metal sieve plate.

Even further, regarding the third object of the present disclosure, the technical solution II of the present disclosure is:

On the basis of technical solution I, the column tube is internally filled with a stationary phase, and a polymer impermeable membrane is disposed inside the stationary phase at the position close to the inflow end of the mobile phase; the outer diameter of the polymer impermeable membrane is smaller than the inner diameter of the column tube; and the central axis of the polymer impermeable membrane coincides with the central axis of the column tube, and the polymer impermeable membrane is parallel to the cross section of the column tube.

Preferably, the polymer impermeable membrane is a liquid-impermeable membrane, which may be made of a fluorine-containing polymer material, preferably a polyester film or a nylon film.

Preferably, the gap between an outer periphery of the polymer impermeable membrane and an inner wall of the column tube is less than ¼ of the inner diameter of the column tube. Further preferably, the gap between the outer circumference of the polymer impermeable membrane and the inner wall of the column tube is 0.6 to 3. According to extensive research by the inventor, when the gap is 0.6 to 3, a better rectification effect will be achieved.

Preferably, a metal sieve plate is disposed above the polymer impermeable membrane to support the polymer impermeable membrane and prevent same from being deformed.

Preferably, the structure of the supporting pore plate may be exactly the same as that of the clastic soft board.

Even further, regarding the fourth object of the present disclosure, the technical solution III of the present disclosure is:

On the basis of technical solution I or technical solution II, further, there are at least three filler layers inside the stationary phase, different fillers are available in the different filler layers, and the different filler layers are separated from one another by metal sieve plates.

From the inflow end to the outflow end of the mobile phase, the stationary phase includes an adsorption layer, a focusing layer and a separation layer, where the adsorption layer is selected from an octadecyl silane bonded silica gel filler, a sulfonic acid-based cationic polymer filler or a naphthyl bonded silica gel filler; the focusing layer is selected from a phenyl bonded silica gel filler or an octadecyl silane bonded silica gel filler; and the separation layer is selected from a cyano bonded silica gel filler, a sulfonic acid-based cationic polymer filler or an octadecyl silane bonded silica gel filler.

Preferably, the depth of the adsorption layer is within a range of 1 mm to 30 mm, the depth of the focusing layer is within a range of 1 mm to 20 mm, and the depth of the separation layer is within a range of 5 mm to 50 mm.

Preferably, the filler particle size of the adsorption layer is 5 μm to 20 μm, the filler particle size of the focusing layer is 2 μm to 5 μm, and the filler particle size of the separation layer is 2 μm to 10 μm.

### (III) the Principle of the Present Disclosure:

1. Description of the Principle that the Extraction Column with Pressure-Variable Pores is Easy to Clean and can Prolong the Service Life of the Extraction Column:

According to the present disclosure, as a pressure-variable pore soft plate and a polymer membrane are disposed inside the column head at the inlet end, the extraction column has a background pressure of about 2 MPa corresponding to the one-dimensional mobile phase, which is not sufficient to form a high pressure. When a high flow rate assists the mobile phase to enter, a high pressure is formed, which generally reaches 10 MPa or more. The elastic soft board shrinks downward, with the pore size becoming smaller, so as to intercept and filter particles, and finer impurities are intercepted and filtered by the polymer membrane; and the supporting pore plate is configured to support the clastic soft board and the polymer membrane. During online and offline reverse cleaning, the pressure is reduced, the elastic soft board is deformed and expanded, and the impurities intercepted by the organic polymer filter membrane and the elastic soft board are eluted and discharged in reverse. An extraction column with pressure-variable pores can more easily wash out impurities reversely at the inlet end of the extraction column, thereby prolonging the service life of the extraction column.

2. Description of the Principle that the Polymer Impermeable Membrane can Reshape the Mobile Phase to Improve Column Efficiency:

In a normal chromatographic column, after a sample flows through the stationary phase along with the mobile phase, the stationary phase loses its adsorption capacity with the accumulation of impurities such as proteins in the sample, causing the target substances in the sample to make various irregular movements. The flow rate closest to the center of the chromatographic column is the highest, while the flow rate near the periphery of the chromatographic column is low and uneven. The present disclosure reshapes the fluid by adding the polymer membrane with deformation characteristics. The fluid first contacts the polymer impermeable membrane. Due to the membrane's lack of selective permeability, the morphology of the fluid changes from longitudinal to transverse, and then the fluid flows out uniformly from the periphery of the polymer membrane with the deformation characteristics. The flow rate becomes uniform and the flow direction becomes regular, so as to enable the target substances in the sample to be rearranged after rectification, and move forward in unison. Therefore, the peak shape of the extraction column is significantly improved.

3. Description of the Principle that the Non-Equal Diameter Extraction Columns can be Adapted to Large Volume Injection:

The most commonly used form of the Van Deemter equation is as follows:

$$H = A - \frac{B}{μ} - C \cdot μ$$

in the formula, H is the height equivalent to a theoretical plate, A, B and C are constants, and μ represents the linear velocity of the mobile phase in the chromatographic column. The formula directly reflects the influence of the linear velocity of the mobile phase in the chromatographic column on the separation. The greater the linear velocity of the mobile phase in the chromatographic column, the worse the column efficiency.

In addition, according to the theory of mathematical constants of chromatographic columns, the linear velocity of the mobile phase inside the chromatographic column is inversely proportional to the square of the inner diameter of the chromatographic column. That is to say, the smaller the inner diameter of the chromatographic column, the greater the linear velocity of the mobile phase inside the chromatographic column, and the worse the column efficiency.

Then, for large volume injection, in order to achieve a better column efficiency, it is possible to consider changing the inner diameter of the column tube to solve the problem of large volume injection. However, if the inner diameter of the extraction column is simply expanded, other problems will also occur, for example, 1) more fillers need to be filled, which increases the cost of the extraction column; 2) the more fillers, the longer the analysis time; 3) the larger the inner diameter of the chromatographic column, the more solvent it contains; and when the solvent is transferred to the next stage of the chromatographic column, it will cause solvent diffusion, thus affecting subsequent analysis.

After extensive research by the inventor, the inventor has developed a multi-stage non-equal diameter chromatographic column that can meet the requirements of large volume injection, maintain good column efficiency, save costs, and provide appropriate analysis time.

The inner diameter of the upper section of the multi-stage non-equal diameter chromatographic column is greater than that of the lower section thereof. The linear velocity of the mobile phase in the upper section of the chromatographic column is low, which is conducive to separation and aggregation, and can be well adapted to large volume injection while maintaining overall good column efficiency. Furthermore, the inner diameter of the upper section is relatively large, which makes the pressure low, thus reducing the damage to the chromatographic column during large volume injection and prolonging the service life of the extraction column. By buffering in the upper section of the chromatographic column, the inner diameter of the lower section of the chromatographic column does not need to be as large as the inner diameter of the upper section thereof, which can reduce the inner diameter. The flow rate of the mobile phase will be increased relative to the upper section, which can reduce analysis time, reduce the amount of the fillers, and save costs.

Furthermore, due to the different flow rates in the upper and lower sections, we further studied the filling of the fillers. The upper and lower sections are respectively filled with different fillers to meet the requirements for separation or enrichment at different flow rates. The upper section may be filled with SCX ionic fillers with strong adsorption properties. The lower section may be filled with fillers such as C18, C8, phenyl, and naphthyl. After optimizing the internal fillers, the enrichment effect has been improved.

The selection principle of the fillers: the particle sizes of the fillers filled into the upper section are larger than those of the fillers filled into the lower section filler, the particle sizes of the upper section are generally selected within a range of 5-50 μm, and the particle sizes of the lower section are generally selected within a range of 2-10 μm: the enrichment ability of the fillers filled into the upper section to the target substances is larger than that of the fillers filled into the lower section.

4. Description of the Principle that Segmented Filling with Different Fillers (Functional Partitions) can Improve the Separating Effect:

After the sample of the present disclosure enters the chromatographic column through the mobile phase, the adsorption layer preliminarily adsorbs some ionic compounds in the sample through ionic forces. The target substances are eluted from the adsorption layer through the mobile phase, and the flow state of the sample is rearranged after the sample is subjected to focusing by an auxiliary mobile phase at a certain flow rate. After reaching the focusing layer, some other impurities are effectively adsorbed through non-polar forces between functional groups, surface electric field forces, and the like. The target substances are rearranged and effectively separated through the separation layer.

(IV) Compared with the Prior Art, the Present Disclosure has the Following Advantages.

1. The extraction column provided by the present disclosure has the pressure-variable pore structure, which can more easily wash out impurities reversely from the inlet end of the extraction column, thereby prolonging the service life of the extraction column.

2. The extraction column provided by the present disclosure has a rectifying structure that rectifies the fluid morphology and flow rate of a fluid entering the chromatographic column, resulting in more uniform dispersion of the sample after rectification, which is more conducive to sample separation, column efficiency improvement, and better peak shape of the extraction column.

3. The extraction column provided by the present disclosure has a non-equal diameter structure, with the inner diameter of the upper section of the column tube being larger than that of the lower section. During large volume injection, the flow rate in the upper section is low, which is conducive to separation and aggregation, and can be well adapted to large volume injection while maintaining overall good column efficiency, thus prolonging the service life of the extraction column, without significantly increasing costs and analysis time.

4. The extraction column provided by the present disclosure has a filler structure with functional partitions, which distinguishes the functions of the extraction column by filling different fillers in sections, resulting in a better separation effect for complex samples. Furthermore, it has a good retention effect on some drugs that are difficult to analyze.

The detailed structure of the present disclosure will be further described below in conjunction with the accompanying drawings and specific embodiments.

### BRIEF DESCRIPTION OF THE DRAWINGS

FIG. 1 is a schematic diagram of the cross-sectional structure of an extraction column provided in Example 1 according to the present disclosure;

FIG. 2 is a schematic diagram of the split structure of the extraction column provided in Example 1 according to the present disclosure;

FIG. 3 is a schematic diagram of the top view structure of an elastic soft board according to the present disclosure;

FIG. 4 is a schematic diagram of the structure of a column tube of the extraction column provided in Example 1 according to the present disclosure;

FIG. 5 is a schematic diagram of the cross-sectional structure of an extraction column provided in Example 3 according to the present disclosure;

FIG. 6 is an enlarged schematic diagram of the structure at point A in FIG. 5;

FIG. 7 shows a peak diagram obtained from the test for the extraction column provided in Example 1;

FIG. 8 shows a peak diagram obtained from the test for a conventional extraction column provided in Comparative Example 1;

FIG. 9 shows a peak diagram obtained from the test for an extraction column provided in Example 2;

FIG. 10 shows a peak diagram obtained from the test for a conventional extraction column provided in Comparative Example 2;

FIG. 11 shows a peak diagram obtained during different injection volumes for the extraction column provided in Example 2;

FIG. 12 shows a peak diagram obtained during different injection volumes for the extraction column provided in Comparative Example 2;

FIG. 13 is a comparison diagram of the relationships between the peak areas of the extraction columns provided in Example 2 and Comparative Example 2 and the different injection volumes therefor;

FIG. 14 is a comparison diagram of the separation and impurity removal effects of clozapine in the tests using extraction columns provided in Example 3 and Comparative Example 3;

FIG. 15 is a comparison diagram of the focusing effect of phenobarbital on the extraction columns provided in Example 3 and Comparative Example 3;

FIG. 16 is a schematic diagram of the structure of a column tube of the extraction column provided in Example 2;

FIG. 17 is a structural diagram of the conventional extraction columns described in Comparative Examples 1 and 2.

### DETAILED DESCRIPTION OF THE EMBODIMENTS

### Example 1

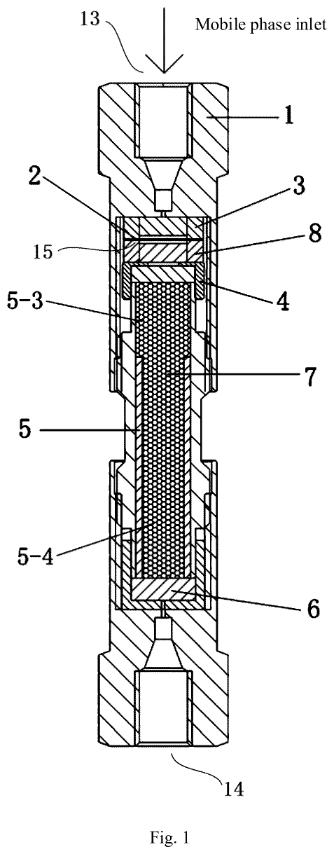

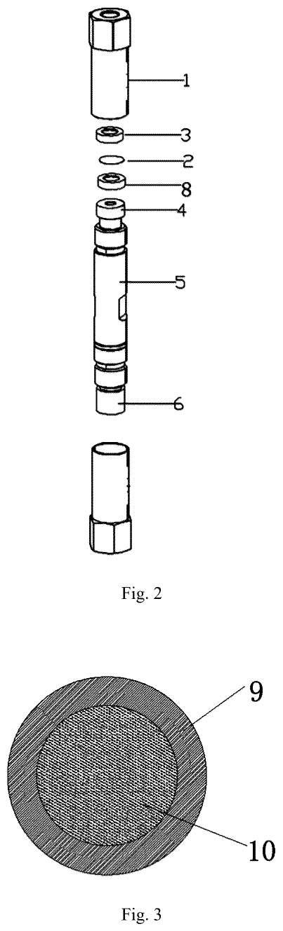

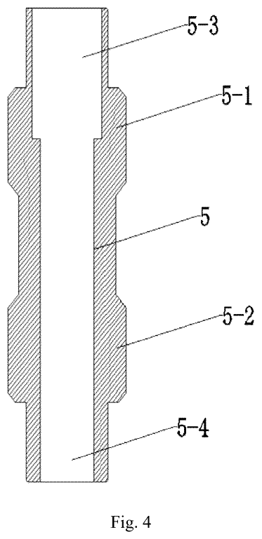

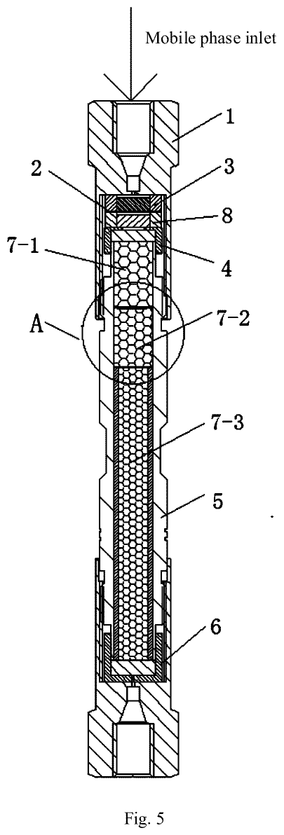

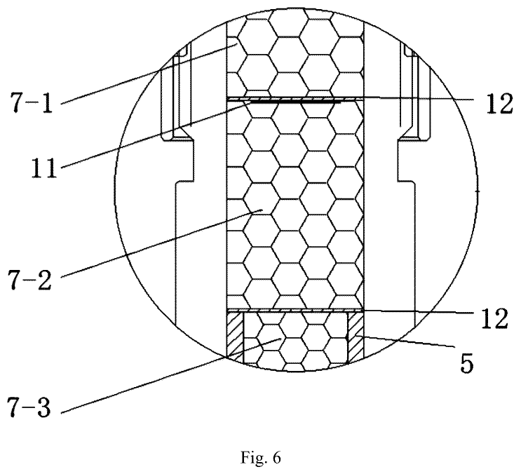

As shown in FIG. 1 to FIG. 2, an extraction column with a pressure-variable pore structure is provided. With the inflow end 13 of a mobile phase serving as an upper end, the extraction column includes a column head 1, a front end column cap 4, a column tube 5, a tail end column cap 6 and a column head 1 which are sequentially connected from top to bottom, where an elastic soft board 3, a polymer filter membrane 2 and a supporting pore plate 8 (the elastic soft board 3, the polymer filter membrane 2 and the supporting pore plate 8 form the pressure-variable pore structure 15) are disposed at an front end of the front end column cap 4 in sequence from top to bottom; the column head 1 is internally provided with a hole for the inflow or outflow of the mobile phase; the column tube 5 is internally filled with a stationary phase 7; the column tube 5 is divided into an upper section 5-3 and a lower section 5-4, with the inner diameter of the upper section 5-3 being greater than that of the lower section 5-4; the length of the upper section 5-3 accounts for ¼ of the length of the column tube 5; and the ratio of the inner diameter of the upper section 5-3 to the inner diameter of low section 5-4 is 1.3.

The front end column cap 4 is disposed at an inlet end of the column tube 5, and the tail end column cap 6 is disposed at an outlet end of the column tube 5. The inlet end and outlet end of the column tube are accommodated inside the column head 1. Internal threads are provided in the column head 1, and the column tube 5 and the column head 1 are connected by the threads.

The supporting pore plate 8 may be a support mesh plate, or the support pore plate 8 is composed of a PEEK ring and a PE sieve plate, where the PEEK ring is made of polyether ether ketone, and the PE sieve plate is made of polyethylene. The material has the characteristics such as high strength and easy dissolution.

The column tube 5 and the column head 1 are both made of stainless steel.

The thickness of the clastic soft board 3 is 0.5 mm, the pore size of the elastic soft board 3 is 5 microns, the thickness of the polymer filter membrane 2 is 0.1 mm, and the polymer filter membrane 2 can intercept substances with molecular weights greater than 3000 Da.

The stationary phase 7 is an octadecyl bonded silica gel filler.

Description of working principle: After protein precipitation treatment, a blood sample with complex matrices enters the extraction column along with the liquid chromatography mobile phase. Impurities with high molecular weights in the sample are intercepted when passing through the clastic soft board, while substances with low and medium molecular weights pass through an elastic filter plate and then are intercepted and filtered for the second time when passing through the organic polymer filter membrane. Finally, the analyte with low or medium molecular weight and some impurities in the sample enter the stationary phase of the extraction column after passing through a second-stage elastic soft board and anti-blocking filter cap. Through the chromatographic force of the stationary phase of the extraction column, the analyte is preliminarily separated out from the sample, flows into a pipeline through an outlet filter cap, and enters other separation or detection systems. After multiple or single offline or online treatment of complex samples, this extraction column with elastic blocking can be reversely washed and purified using the mobile phase with a certain elution strength. At this time, the impurities intercepted by the organic polymer filter membrane and the clastic soft board can deform during the expansion and contraction of the elastic soft board, thus promoting the discharge of the impurities and completing the self purification of the extraction column. Furthermore, the inner diameter of the upper section of the multi-stage non-equal diameter chromatographic column is greater than that of the lower section thereof. The linear velocity of the mobile phase in the upper section of the chromatographic column is low, which is conducive to separation and aggregation, and can be well adapted to large volume injection while maintaining overall good column efficiency. Furthermore, the inner diameter of the upper section is relatively large, which makes the pressure low, thus reducing the damage to the chromatographic column during large volume injection and prolonging the service life of the extraction column.

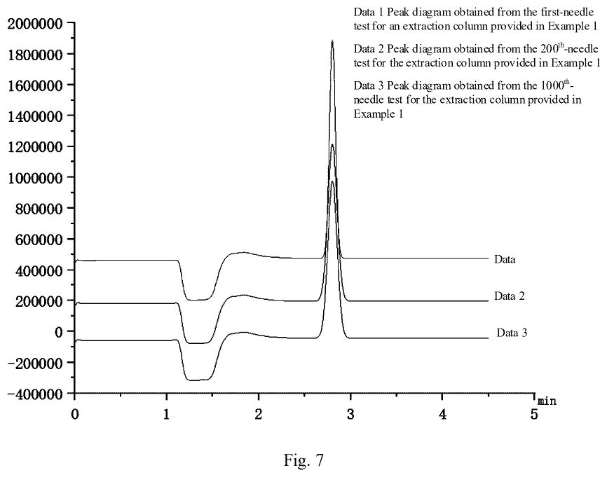

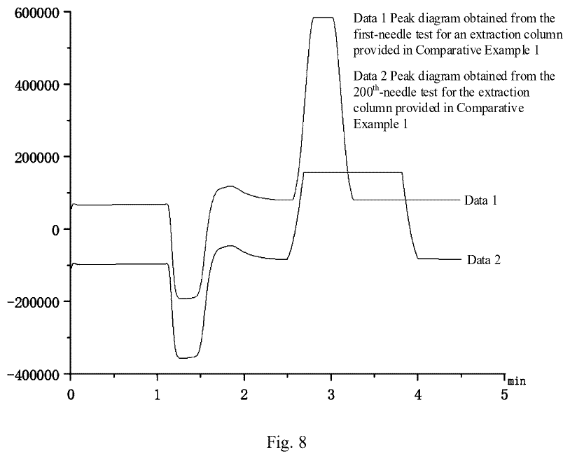

The extraction column of Example 1 and the conventional extraction column (without pressure-variable pore and non-equal diameter structures) of Comparative Example 1 were subjected to a comparison test in a two-dimensional liquid chromatography system to test the content of valproic acid in human blood, and the blood was treated with 5% perchloric acid. A detector as the test instrument was Shimadzu SPD-20A, the wavelength was 215 nm, the mobile phase was 30% of acetonitrile: 70% of water, the flow rate was 1.0 mL/min, the auxiliary mobile phase was water, the auxiliary flow rate was 2.0 mL/min, the auxiliary time was 0.6 min, the column temperature was 40° C., and the injection volume was 500 μL. According to the non-equal diameter extraction column with pressure-variable pores of Example 1, after testing for 200 needles, the peak pattern still did not diffuse and was good in peak shape. The pressure remained stable and could withstand the impact of 1000 needles, as shown in FIG. 7. After the conventional extraction column (without pressure-variable pore and non-equal diameter structures, the other structures were consistent) was tested for 200 needles, the peak pattern widened as shown in FIG. 8, and the pressure gradually increased. The specific pressure performance indicators are shown in Table 1.

Comparative Example 1 is a conventional extraction column, with the other structures the same as Example 1, except for the addition of the existing conventional filter at the front end thereof to filter impurities. Difference 2 lies in its inner diameter being 4.6 mm, which is an equal diameter structure. The two-dimensional liquid chromatography system has a reverse cleaning function. The conventional chromatographic column and the extraction column provided by the example are both tested in the chromatography system with the reverse cleaning function, with one needle of analysis performed and then reversely cleaned once.

Table 1 is a pressure comparison table of extraction columns in Example 1 and Comparative Example 1.

| Number of injection needles | 1 | 100 | 200 | 245 | 600 | 800 | 1000 |
|---|---|---|---|---|---|---|---|
| Extraction Column Pressure | 3.99 | 3.99 | 3.99 | 3.99 | 3.99 | 4.18 | 4.18 |
| in Example 1 | | | | | | | |
| Extraction Column Pressure | 3.89 | 12.6 | 25 | Overpressure | — | — | — |
| in Comparative Example 1 | | | | alarm | | | |

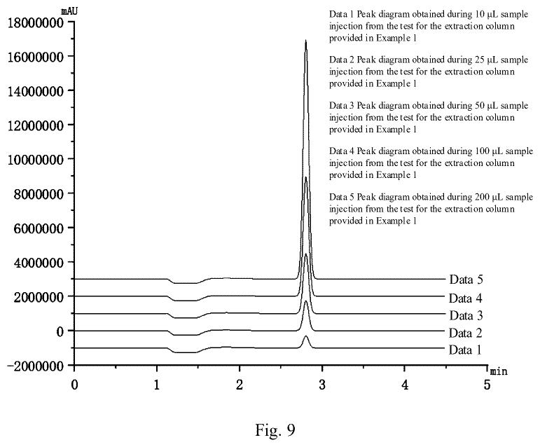

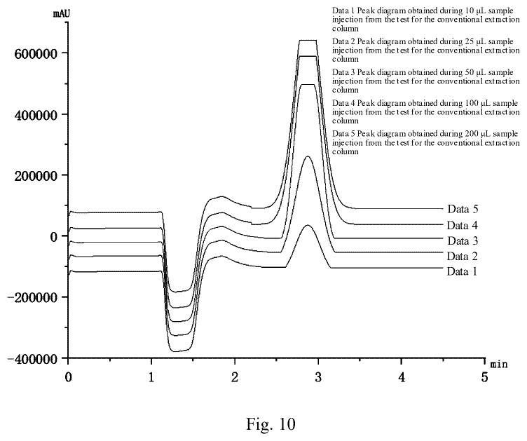

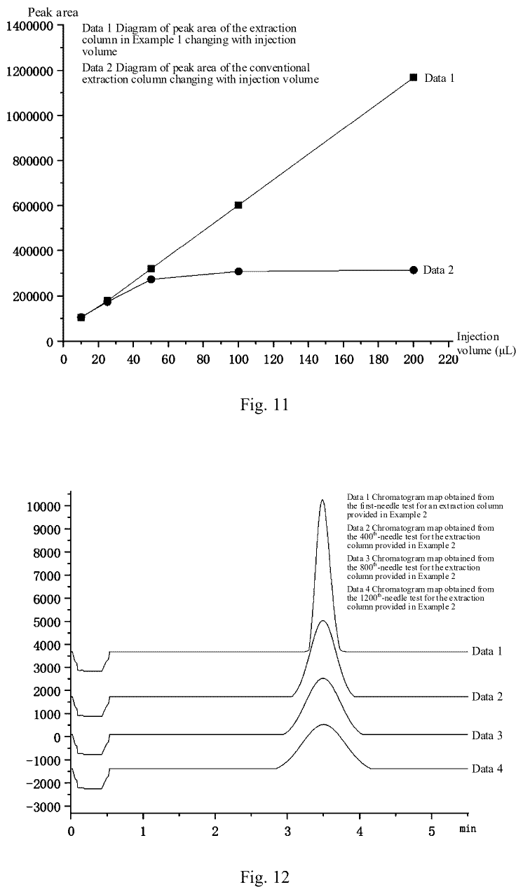

The extraction column of Example 1 and the conventional extraction column (without pressure-variable pore and non-equal diameter structures) were subjected to a comparison test in a two-dimensional liquid chromatography system to test a valproic acid debugging solution, with a concentration of 500 μg/mL. A detector as the test instrument was Shimadzu SPD-20A, the wavelength was 215 nm, the mobile phase was 30% of acetonitrile: 70% of water, the flow rate was 1.0 mL/min, the auxiliary mobile phase was water, the auxiliary flow rate was 2.0 mL/min, the auxiliary time was 0.6 min, the column temperature was 40° C., and the injection volume was set to 10 μL, 25 μL, 50 μL, 100 μL and 200 μL. Check whether the injection volume and peak area are linear, the specific results are shown in FIG. 9, FIG. 10 and FIG. 11. It can be seen that the extraction column of the present application can withstand large volume injection, while the conventional extraction column exhibits flat peaks and peak areas that are not linear with the injection volume after large volume injection.

### Example 2

The other structures are the same as those in Example 1, with a polymer impermeable membrane 11 located inside the stationary phase 7 at the position close to the inflow end 13. The outer diameter of the polymer impermeable membrane 11 is smaller than the inner diameter of the column tube 5. The central axis of the polymer impermeable membrane 11 coincides with the central axis of the column tube 5, and the polymer impermeable membrane 11 is arranged parallel to the cross-section of the column tube 5. The gap between an outer periphery of the polymer impermeable membrane and an inner wall of the column tube is 0.8 mm.

The polymer impermeable membrane 11 is made of a fluorine-containing polymer material, which has no permeability to liquid.

The column tube 5 is divided into an upper section and a lower section with the polymer impermeable membrane 11 as a boundary, and the upper section and the lower section may be filled with the same stationary phase 7. The loaded stationary phase 7 may be C8.

Description of working principle: In a normal chromatographic column, after a sample flows through the stationary phase along with the mobile phase, the stationary phase loses its adsorption capacity with the accumulation of impurities such as proteins in the sample, causing the target substances in the sample to make various irregular movements. The flow rate closest to the center of the chromatographic column is the highest, while the flow rate near the periphery of the chromatographic column is low and uneven. The present disclosure reshapes the fluid by adding the polymer impermeable membrane. The fluid first contacts the polymer membrane with deformation characteristics. Due to the membrane's lack of selective permeability, the morphology of the fluid changes from longitudinal to transverse, and then the fluid flows out uniformly from the periphery of the polymer impermeable membrane with the deformation characteristics. The flow rate becomes uniform and the flow direction becomes regular, so as to enable the target substances in the sample to be rearranged after rectification, and move forward in unison. Therefore, the peak shape of the extraction column is significantly improved.

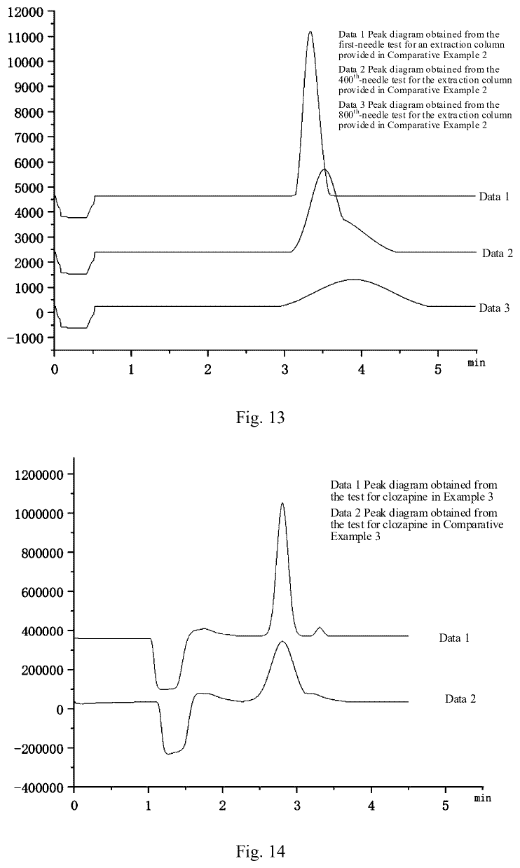

The extraction column of Example 2 and the conventional extraction column (without a rectifying structure) were subjected to a comparison test in a two-dimensional liquid chromatography system to test a levetiracetam biological sample, with an injection volume of 100 μL. A detector was Shimadzu SPD-20A, the wavelength was 232 nm, the mobile phase was 4% of methanol: 96% of water (1 mmol phosphate, pH=3.2), the flow rate was 1.0 mL/min, the auxiliary mobile phase was water, the auxiliary flow rate was 0.5 ml/min, the auxiliary time was 0.5 min, and the column temperature was 40° C. It can be seen from the test results that the molecular interception membrane was added in Example 2, and the peak gradually widened with the accumulation of the number of injection needles, but no obvious tailing was observed in the chromatographic peak. The broadening and tailing of the chromatographic peak can be clearly felt in the conventional extraction column of Comparative Example 2 (without a polymer impermeable membrane). The specific test results are shown in FIG. 12 and FIG. 13.

### Example 3

On the basis of Example 2, taking the processing of a 5 μm extraction column with dimension of 3.5×25 mm as an example

There are at least two filler layers 16 inside the stationary phase 7, different fillers are available in the different filler layers 16, and the different filler layers 16 are separated from one another by metal sieve plates 12.

The extraction column of Example 3 also includes the stationary phase 7 filled in the column tube 5, the stationary phase 7 is divided into three sections, and the metal sieve plate 12 is disposed between any two sections of the stationary phase 7. The adsorption layer 7-1 is a SCX cationic filler, the focusing layer 7-2 is a phenyl bonded silica gel filler, and the separation layer 7-3 is an octadecyl bonded silica gel filler.

The depth of the adsorption layer 7-1 is 5 mm, the depth of the focusing layer 7-2 is 5 mm, and the depth of the separation layer 7-3 is 15 mm. The filler particle size of the adsorption layer 7-1 is 15 μm, the filler particle size of the focusing layer 7-2 is 3.5 μm, and the filler particle size of the separation layer 7-3 is 5 μm.

### Comparative Example 3

The other structures are the same as those in Example 3, except that functional partitioning is not performed, and the filled filler is an octadecyl bonded silica gel filler.

After clozapine is metabolized, it will produce the metabolite norclozapine, which will affect the determination of clozapine in human blood samples by liquid chromatography. Furthermore, phenobarbital has a relatively low content in human blood samples and is prone to diffusion, making it difficult to determine using the conventional liquid chromatography columns.

A two-dimensional liquid chromatography system (with a reverse cleaning function) was used for the determination of clozapine biological samples. The chromatographic conditions were as follows: a detector was SPD-20A, the wavelength was 290 nm, the mobile phase was 26% of acetonitrile: 74% of water (pH: 7.0), the flow rate was 0.7 mL/min, the column temperature was 40° C., the auxiliary solvent was an aqueous solution, the auxiliary flow rate was 2.0 mL/min, the auxiliary time was 1.0 min, and the injection volume was 200 μL. The test results are shown in FIG. 14.

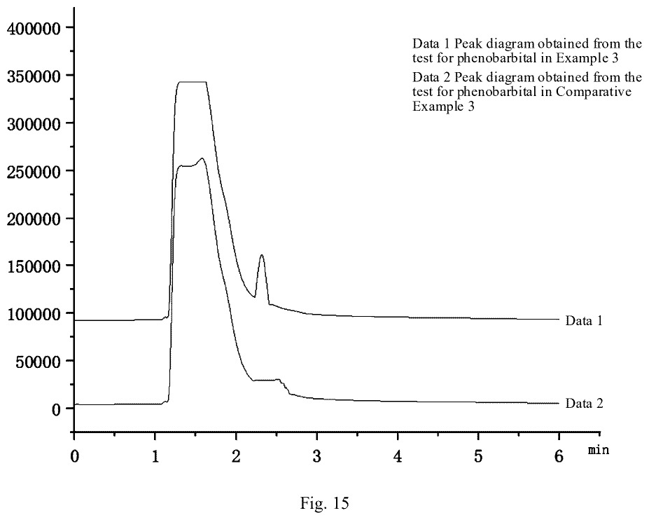

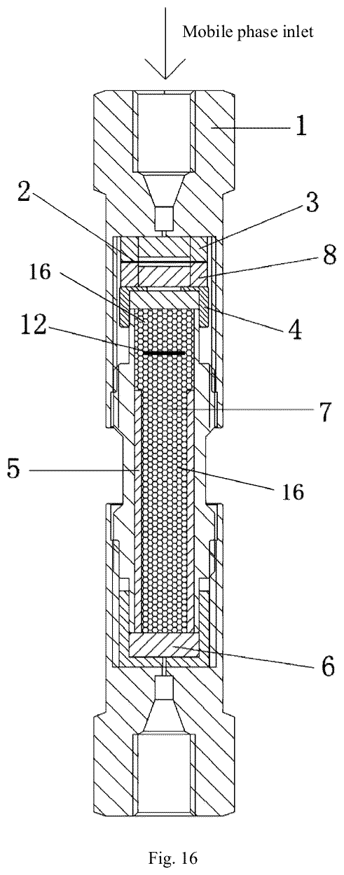

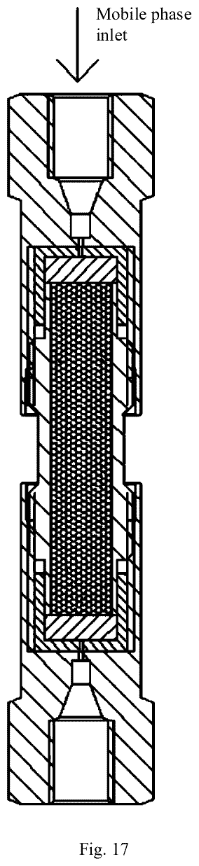

A two-dimensional liquid chromatography system was used for the determination of phenobarbital biological samples. The chromatographic conditions were as follows: a detector was SPD-20A, the wavelength was 235 nm, the mobile phase was 30% of acetonitrile: 70% of water, the flow rate was 1.0 mL/min, the column temperature was 40° C., the auxiliary solvent was a 0.5% formic acid solution, the auxiliary flow rate was 2.0 mL/min, and the auxiliary time was 0.6 min. The test results are shown in FIG. 15.

It can be seen from FIG. 14 and FIG. 15 that the extraction column of Example 3 has a better separation ability for complex biological samples containing clozapine than the extraction column of Comparative Example 3. Meanwhile, Example 3 can enable an effective intercept window for phenobarbital-containing biological samples that are more difficult to detect.

The foregoing descriptions are specific embodiments of the present disclosure, but the protection scope of the present disclosure is not limited thereto. Any equivalent replacement or modification made by those skilled in the art according to the technical solutions and concepts of the present disclosure within the technical scope disclosed by the present disclosure shall be covered by the protection scope of the claims of the present disclosure.

What is claimed is:

1. A multi-mode anti-matrix extraction column, wherein with the inflow end of a mobile phase serving as an upper end, the extraction column comprises a column head, a front end column cap, a column tube, a tail end column cap and a column head which are sequentially connected from top to bottom, wherein an inner cavity of the column tube is cylindrical, the column tube is divided into an upper section and a lower section, and the inner diameter of the upper section is larger than that of the lower section; and a pressure-variable pore structure is provided on an upper end of the front end column cap, and comprises an elastic soft board, a polymer filter membrane and a supporting pore plate in sequence from top to bottom.

2. The multi-mode anti-matrix extraction column according to claim 1, wherein the column tube is internally filled with a stationary phase, and a polymer impermeable membrane is disposed inside the stationary phase at the position close to the inflow end; the outer diameter of the polymer impermeable membrane is smaller than the inner diameter of the column tube; and the central axis of the polymer impermeable membrane coincides with the central axis of the column tube, and the polymer impermeable membrane is parallel to the cross section of the column tube.

3. The multi-mode anti-matrix extraction column according to claim 1, wherein there are at least two filler layers inside the stationary phase, different fillers are available in the different filler layers, and the different filler layers are separated from one another by metal sieve plates.

4. The multi-mode anti-matrix extraction column according to claim 1, wherein the elastic soft board comprises a fixed ring and an elastic sieve plate, and the elastic sieve plate is located inside the fixed ring.

5. The multi-mode anti-matrix extraction column according to claim 1, wherein the thickness of the elastic soft board is 0.1 mm-10 mm, and the pore size of the elastic soft board is 5 microns to 10 microns.

6. The multi-mode anti-matrix extraction column according to claim 1, wherein the thickness of the polymer filter membrane is 0.05 mm-3 mm, and the polymer filter membrane can intercept substances with molecular weights greater than 3000 Da.

7. The multi-mode anti-matrix extraction column according to claim 2, wherein the gap between an outer periphery of the polymer impermeable membrane and an inner wall of the column tube is less than ¼ of the inner diameter of the column tube.

8. The multi-mode anti-matrix extraction column according to claim 2, wherein the gap between the outer periphery of the polymer impermeable membrane and the inner wall of the column tube is 0.6-3 mm.

9. The multi-mode anti-matrix extraction column according to claim 1, wherein the length of the upper section accounts for ⅕- 3/10 of the length of the column tube.

10. The multi-mode anti-matrix extraction column according to claim 1, wherein the ratio of the inner diameter of the upper section to the inner diameter of the lower section is 1.2-1.5.

11. The multi-mode anti-matrix extraction column according to claim 3, wherein from the inflow end to the outflow end of the mobile phase, the stationary phase comprises an adsorption layer, a focusing layer and a separation layer, wherein the adsorption layer is selected from an octadecyl silane bonded silica gel filler, a sulfonic acid-based cationic polymer filler or a naphthyl bonded silica gel filler; the focusing layer is selected from a phenyl bonded silica gel filler or an octadecyl silane bonded silica gel filler; and the separation layer is selected from a cyano bonded silica gel filler, a sulfonic acid-based cationic polymer filler or an octadecyl silane bonded silica gel filler.

12. The multi-mode anti-matrix extraction column according to claim 3, wherein the depth of the adsorption layer is within a range of 1 mm to 30 mm, the depth of the focusing layer is within a range of 1 mm to 20 mm, and the depth of the separation layer is within a range of 5 mm to 50 mm.

13. The multi-mode anti-matrix extraction column according to claim 3, wherein the filler particle size of the adsorption layer is 5 μm-20 μm, the filler particle size of the focusing layer is 2 μm-5 μm, and the filler particle size of the separation layer is 2 μm-10 μm.
